(19) United States
(12) Patent Application Publication
(10) Pub. No.: US 2008/0204237 A1
(43) Pub. Date: Aug. 28, 2008

(54) RFID tag with security features

(76) Inventor: Eduard Levin, Thornhill (CA)

Correspondence Address: DAVID W. WONG, 46 WILLOWBROOK ROAD, THORNHILL, ON, L3T 4W9, omitted

(21) Appl. No.: 11/709,998

(22) Filed: Feb. 26, 2007

(51) Int. Cl. G08B 13/14

(52) U.S. Cl. 340/572.1

(57) ABSTRACT

The apparatus is applicable for stock-taking or for controlling items such as vehicles located in a garage. The device is provided with tags having transponders carrying RFID codes individually which may be activated by secure key, in the form of a card, to recognize an authorized access to the items. Auxiliary RFID transponders may be activated by a primary RFID transponder through induced voltage. A receiver upon receiving a signal of electronic code from the secure key will compare it with legitimate electronic codes in the transponder memory. If the code coincides with a legitimate electronic code, a transponder recognition device creates a signal to operate the primary transponder to transmit an information signal carrying the RFID codes.

### BACKGROUND OF THE INVENTION

1. Field of the Invention

This invention relates to systems of maintaining the security of objects with radio frequency transducers such as tags or transponders containing electronic codes for their recognition. Such devices are commonly known as radio frequency identification devices (RFID). More specifically, this invention relates to radio frequency methods of recognition of tags with RFID tag and tag activation device. A RFID consists of a reader and a plurality of transponders. The latter are affixed on objects which are subject to inventory or security and are located in a storage facility such as a warehouse or garage.

2. Description of Prior Art

RFID methods and systems provide the recognition of objects with identification tags affixed thereon. In the process of tag recognition it is necessary to determine the tag parameters which depend on the state of the object of inventory such as a vehicle located in a garage. In a garage is equipped with RFID tracking and recognition system every vehicle in it would be provided with a RFID tag carrying the electronic code which is transmitted to a central station so that the vehicle may be readily located, retrieved and the amount of parking charge is calculated.

Each RFID consists of a reader and a transponder having a unique electronic identification code. The transponder may be affixed under the wind shield of the vehicle. Readers are provided for primarily reading tag codes and searching for the location of the tag. The tag transmits an information signal to the reader to provide the information such as the time of arrival of the vehicle at the garage, the parking location. Thus processing of the tag signal in a reader would provide the following data:

time of arrival and departure of the vehicle;

location in a definite parking spot in garage; and

authorization of the person driving the vehicle.

Usually the time of arrival and departure can be provided to the central parking control computer by gate sensors located at the entrance to the garage. Vehicle location at a definite parking spot can be determined by methods of triangulation, coordinate sensors or similar systems. For authorization of the vehicle driver, present known control systems are not provided with such security so that any vehicle in a garage can be stolen by a thief by merely breaking into the vehicle either with a stolen ignition key or jump starting it and paying the parking charge. In order to eliminate such drawback the RFID system must be provided with a security feature by informing the central control computer of the garage with the essential information whether the vehicle is driving by an authorized person.

U. S. Patent Application No.US2006/0176154 A1 to S. C. Littlechild and M. J. Stanton, published Aug. 10, 2006, describes a RFID transponder having dynamic memory array that stores data. Transponder in the system has an option to interrogate with reader and extract identifier from interrogation signal with the possibility to determine whether some or all of the identifier stored in the memory.

Canadian Patent application No.2,404,011 to R. Kirkham et al, published Oct. 4, 2001, illustrates an authentication system providing access to the product upon verification of the encrypted authorization code by interrogation between a tag and a reader.

U. S. Patent Application No.2004/0160323 A1 to L. A. Stilp, published Aug. 19, 2004, describes a security system with a tag connected to the intrusion sensor. RFIDs tag may be carried by persons or animals and may be activated in case of emergency.

U. S. Patent Application No.2005/0212662 A1 to Franz Amtmann et al, published on Sep. 29, 2005, shows a technical solution where a transponder contains a product code relative to the product location.

U. S. Patent Application No.2005/0242921 to T. M. Zimmerman et al, published on Nov. 3, 2005, describes a mobile key including a RFID tag associated with a memory which holds a secure access code.

All of the above prior art failed to teach, or even suggest, any RFID transponder having features which can perform a security option for providing the vehicle owner with a specific secure access key after parking the vehicle in a garage as well as providing the central control computer of the garage with information if the vehicle is driven by an authorized person so as to prevent theft of the vehicles parking in the garage.

### SUMMARY OF THE INVENTION

It is the principal object of the present invention to provide a RFID system having security features capable of associating an object with a rightful owner, such as articles located in a warehouse, vehicles parked in a parking garage. The system is equipped with a RFID transponder i.e. a RFID tag, with the purposes of:

recognition;

checking the time-in and time-out (namely arrival and departure);

location of it in a definite area; and

authorization of the rightful owner.

In order to ensure the above features, the transponder of the present invention transmits an RF signal with an electronic code specifically assigned for the article or object of inventory concerned, and is to be under surveillance for recognition as well as calculating the time of storage. A RFID reader with spatially distributed antennas is provided to locate the position of the object. If the subject changes its location, the RFID reader is capable of locating the new position with signal processing from the transponder attached to the object. Moving of the object is authorized so as to prevent theft and other mischief action of the object. In according to the present invention, a secure key is provided to the rightful owner of the object to provide such security as well as the following information:

to obtain a physical and electronic access to a transponder or a group of transponders;

to be mobile, small and available for carrying by the rightful owner such as in the pocket or wallet;

to provide the owner with the information about the tagged object's location; and

to use as an information card to pay for the storage or parking of the vehicle.

The above features can be implemented with a mobile secure key which contains a specific electronic code which is recognizable by a RFID transponder attached to the object of inventory and surveillance. The transponder is equipped with a radio frequency receiver, recognition device and memory to carry the electronic code. The receiver acquires the signal from the secure key, selects the electronic code, compares the electronic code with ones from the transponder memory to determine if the secure key electronic code coincides to the memory code. In case of coincidence of the codes, the transponder recognition device would create a signal to control the transponder. There are two ways to provide the secure options, namely to turn the transponder “ON” and “OFF” depending on whether or not the tagged object is under security surveillance; or to implement any secure feature into signal transmission by the transponder for changing signal parameters, frequency, amplitude, phase and to add another alarm signal etc., depending on the alarm system design.

The mobile secure key may serve numerous purposes such as removable from the transponder for stopping the transponder's operating power, to place the object associated with it under the guard, to be used as an identification for checking the state of the object through terminals of the central control station, and to provide a means for indicating the payment required for the length of time of storage and as an access card for removing the object from the storage facility.

The present invention possesses numerous benefits and advantages over known RFID transponders. In particular, it permits the prevention of an unauthorized tagged article from being removed and theft, and it reduces the time of searching for the tagged article when there are a large number of tags to be recognized within an interrogation zone. One embodiment of the invention can be used with existing tags by providing only minor modifications in their power supply stages. The universal character of the system allows it to be used as a mobile or a stationary device selectively.

As a whole, the present invention resolves the complex problem in object security even when a large number of objects are simultaneously located in a diverse conditions; and it is applicable in a wide variety of fields in manufacturing, shipping or storage.

The RFID method and system of the present invention are provided primarily on the creation of a mobile secure key for communicating with the RFID transponder attached to the object of security or inventory. The RFID transponder includes the implementation of a mobile secure key code receiver having recognition stages, control stages and processing mobile secure key signal stages for:

forming a mobile secure key signal;

receiving a mobile secure key signal;

selecting a code from the mobile secure key signl;

comparing code from mobile secure key signal with a code from a transponder memory; and

creating a signal to control the RFID transponder transmitter in case coincidence of the codes occurs.

### BRIEF DESCRIPTION OF THE DRAWINGS

FIG. 1 is a general block diagram of the transponder according to an embodiment of the system of the present invention.

FIG. 2 is a block diagram of the transponder with secure features according to the present invention.

FIG. 3 is a block diagram of a transponder without a power supply switch with the secure features according to the present invention.

FIG. 4 is a block diagram of the transponder using a passive tag as a secure mobile key which is being activated with the transponder power supply according to the present invention.

FIG. 5 is a block diagram of the transponder using a passive tag as a secure mobile key which is being activated with an induced magnetic field according to the present invention.

FIG. 6 is a perspective elevation view showing a method of tag secure features activation by the insertion of a mobile secure key into the transponder slot according to the present invention.

FIGS. 7a through 7d are perspective elevation views showing a mobile secure key serving as an identification and information card according to the present invention.

FIG. 8 is a perspective elevation view showing a transponder with the mobile secure key inserted into its slot and powered with induced magnetic alternating field according to the present invention.

FIG. 9 is a perspective elevation showing a mobile secure key designed as a card having imbedded passive tag therein according to the present invention.

FIG. 10 is perspective side elevation view showing a transponder with the mobile secure key inserted into its slot and powered through connection with contacts therein according to the present invention.

FIG. 11 are graphical illustrations of the signal transmitted by the tag with and without inserted secure key according to the present invention.

FIG. 12 are perspective side and top front elevation views showings a transponder with mobile secure key inserted into the slot therein for powering it with the induced magnetic field according to the present invention.

FIG. 13 is a side elevation view showing a tag collector and transponder with the mobile secure key inserted into the transponder slot therein with designed coinciding holes in their respective cases ready to be stored by the tag collector according to the present invention.

### DETAILED DESCRIPTION OF THE PREFERRED EMBODIMENTS

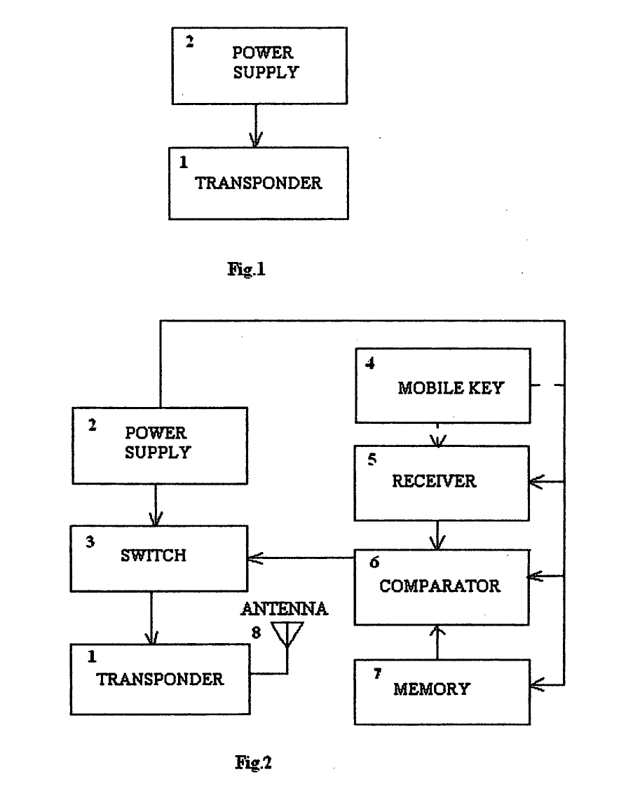

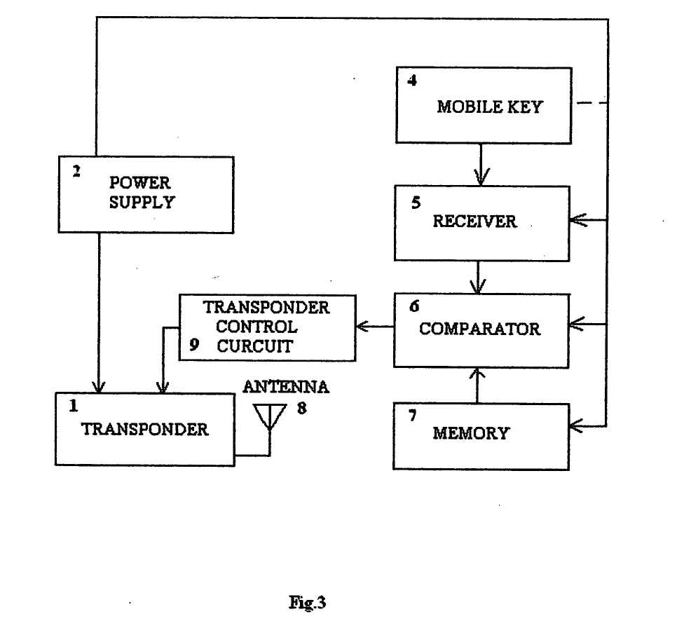

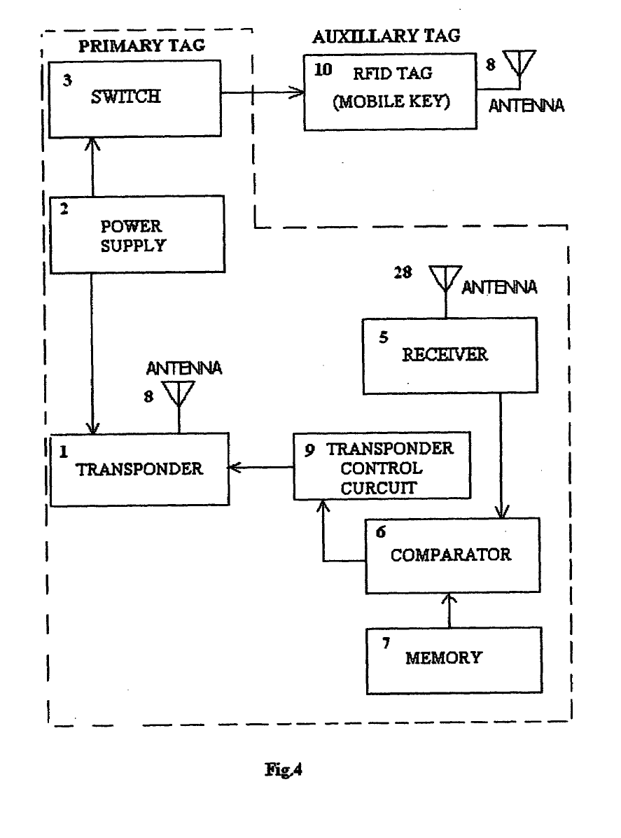

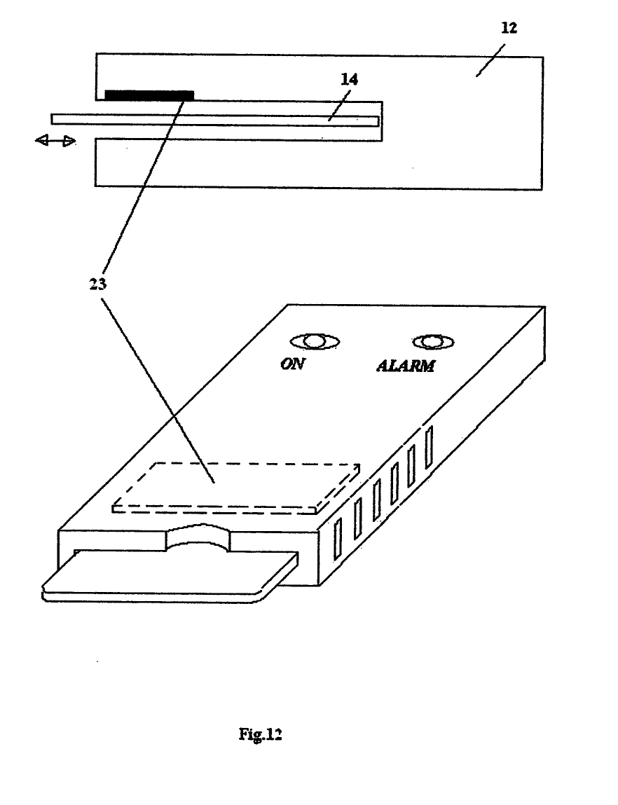

With reference to the drawings, the procedure of using the mobile secure key in the transponder according to the present invention is shown in FIGS. 1 and 2. Any transponder 1 is supplied with operating power from a power supply 2 such as a battery or capacitor charged with induced electric or magnetic field. A transponder transmitter radiates the information signal with an antenna 8. There are two ways to create the security option for the transponder, namely to start or to stop transmitting of the information signal or to control its parameters. The first option supposes the transponder transmits the information signal after an authorized person turns the transponder “ON” with the mobile secure key 4 as shown in FIG. 2. To perform the operation, the transponder should contain switch 3 for connecting the operating power thereto. The mobile secure key 4 contains a secure code. Upon receiving the code, the receiver 5 sends the code to a comparator 6 which compares the received code with the code in the memory 7. In case of a coincidence of the codes, the comparator creates a signal to turn switch 3 ON and to supply the transponder with the require operating power. An alarm system design of the present invention is shown in FIG. 3 in which the transponder signal changes its parameters, namely, frequency, amplitude, and phase by the transponder control circuit 9 connected to the transponder elements. FIG. 11 shows the signal 21 transmitted by the transponder for case A in which the Alarm is “ON”, and the signal 22 for case B in which the Alarm is “OFF”. There is an information signal carrying the identification code for both cases, and the transponder radiates extra alarm signal 27 to recognize unauthorized access.

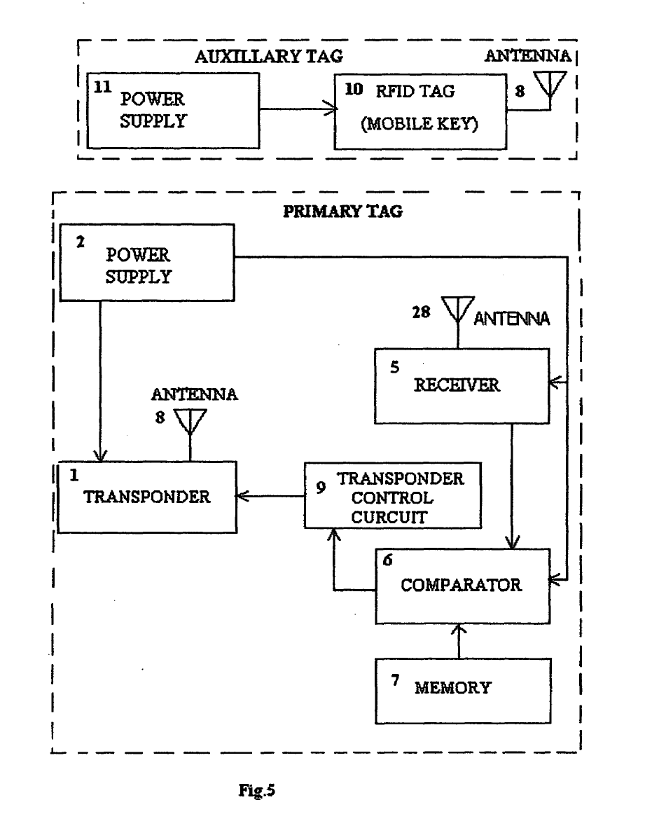

Mobile secure key may be designed as a RFID tag 10 carrying the secure code in its information signal. FIG. 4 shows the block diagram of the transponder using an auxiliary tag as a secure mobile key to control the primary RFID transponder 1. The auxiliary tag may be provided with power by induced magnetic or magnetic field, from its own battery power source or from the battery in the primary tag. FIG. 4 shows the auxiliary tag 10 connected to the primary tag power supply 2 with switch 3. FIG. 5 shows the auxiliary tag having a separate power supply provided by induced magnetic or magnetic field, charging the tag capacitor or by its own battery power source. The coding of the auxiliary tag signal is transmitted with an antenna 8 to the receiver antenna 28 and it contains secure features according to the RFID system design.

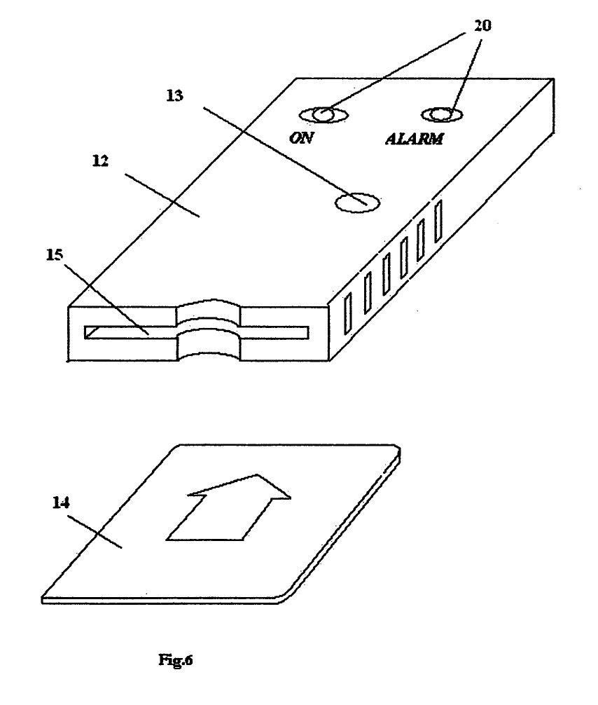

FIG. 6 shows a design of the primary tag 12 with the mobile secure key 14 in the form of a credit card. The mobile secure key 14 is insertable into a slot 15 of the primary tag case 12 equipped with a flashing light 20 to indicate the state of security.

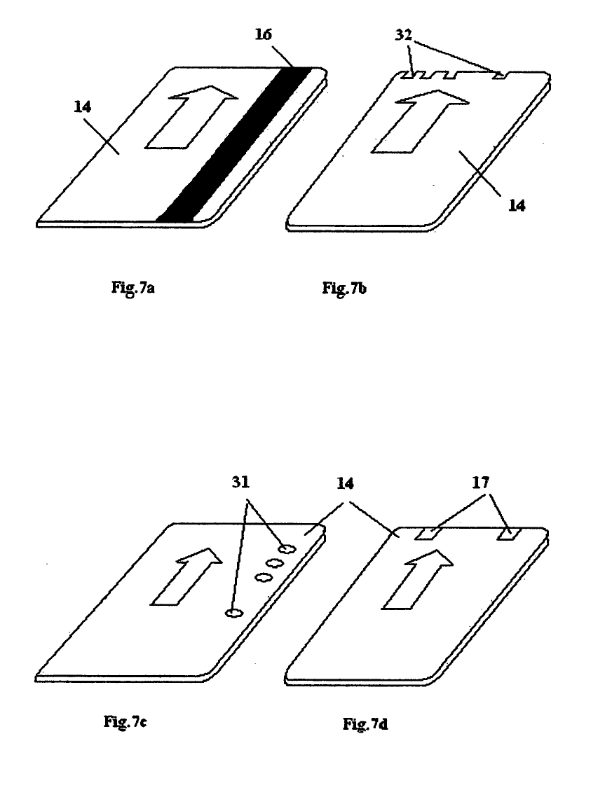

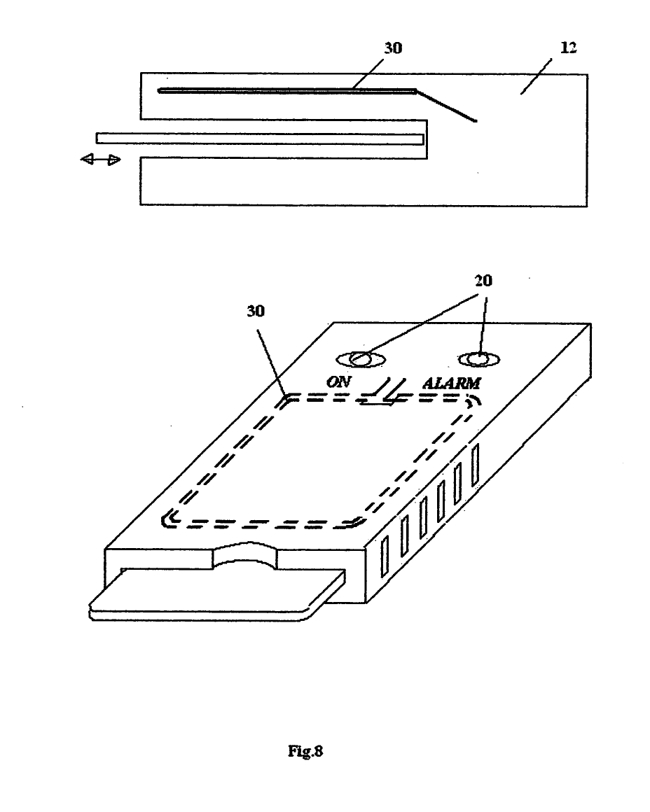

FIG. 7a shows a mobile secure key provided with a magnetic strip 16 carrying the secure ID code readable by the receiver 5 shown in FIGS. 2 and 3.

FIGS. 7b and 7c show a mobile secure key provided with designed card shape features having holes 31 or card edge cuts 32 representing the secure ID code readable by the receiver 5.

FIG. 7d shows a mobile secure key having contacts 17 which may be connected to a RFID tag power bus to energize the tag transmitter and to transmit the information signal containing the secure code. When the tag is being inserted into the primary tag case slot 15, it activates contacts 19 as shown in FIG. 10, coupled to the primary tag power supply so that power is applied to the auxiliary tag to energize it for transmitting the information signal.

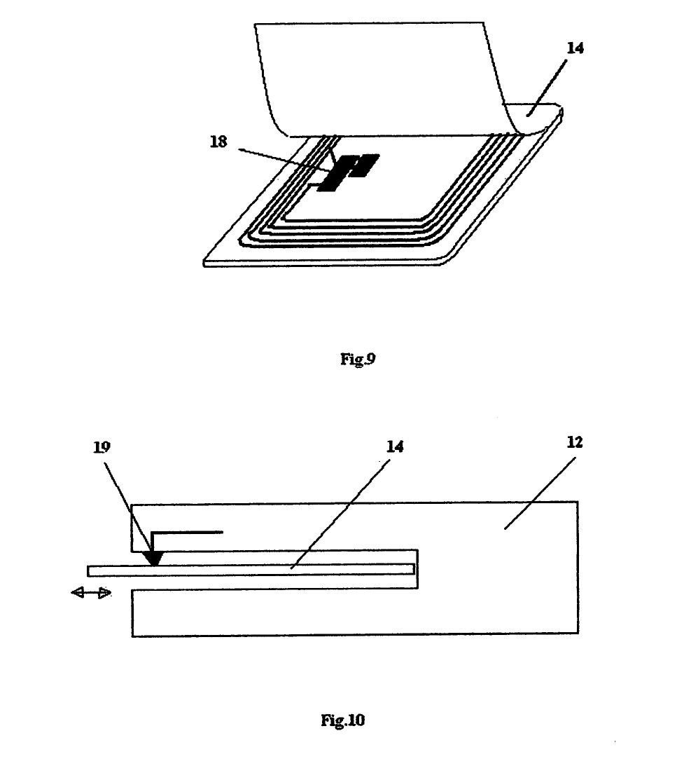

FIG. 8 shows another embodiment of the present invention where the primary tag generates a magnetic alternating field with coil winding 30 embedded into the case of the primary tag 12. The magnetic field induces the electrical current in the coil winding of the auxiliary tag for charging its transponder battery so as to activate it for transmitting the coding signal.

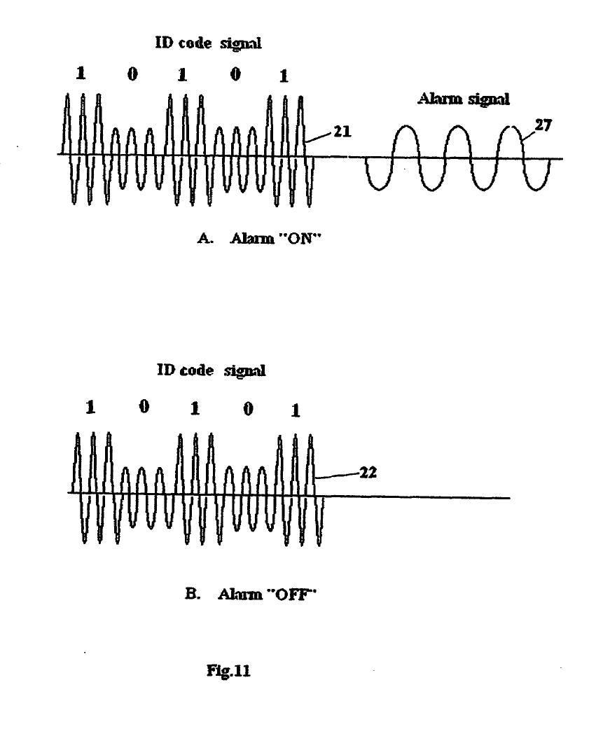

FIG. 9 shows the generation of a voltage in the transponder antenna coil by induction in an auxiliary tag 14 with the RFID transponder imbedded therein.

FIG. 12 shows another embodiment of the present system in which the RFID transponder 18 imbedded into the tag 14 as shown in FIG. 9 is supplied with induced energy from a magnetic strip 23 also imbedded into the primary tag 12 case. The RFID transponder is the passive portion in this case which is powered by the energy of the magnetic field created by the magnetic strip 23 being inserted into the slot 15.

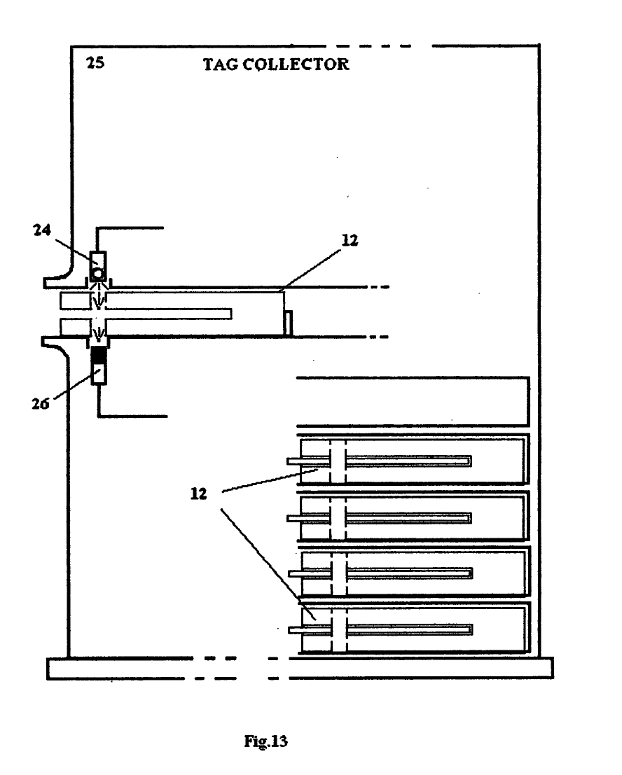

When the transponders are placed in storage in a tag collector 25 as shown in FIG. 13, it is very important that this storage can only accept a complete set of RFID security system consisting of both the primary and the auxiliary tags. To avoid the situation in which the tag collector accepts an incomplete RFID system set, for example, only the primary tag without the auxiliary tag, there is a hole 13 designed in the primary tag 12 case. If the transponder is placed in storage and positioned correctly, but the tag user overlooks to place the mobile key in the light path from any source of light 24 going through the primary tag case, a photo sensor 26 will receive the light signal and this signal may be used at the tag collector control devices to ask the tag user, for example, to insert the auxiliary tag into the primary tag as well.

It is to be understood that variations and modifications of the present invention can be made without departing from the scope of the invention. It is also to understood that the scope of the invention is not to be interpreted as limited to the specific embodiments disclosed herein, but only in accordance with the appended claims when read in light of the foregoing disclosure.

What is claimed is:

1. A method of providing RFID tags with security options, comprising
forming a security signal with secure features and operative for controlling a RFID transponder of said tags,
transmitting said signal to a processor operative for recognizing all secure features in said security signal,
forming an operating signal for operating said RFID transponder upon confirmation of said secure features.

2. A method according to claim 1 wherein said step of forming an operating signal including the steps of
forming an electronic signal containing an electronic code,
transmitting said electronic signal to said RFID transponder,
selecting a selected electronic code from said electronic signal,
comparing said selected electronic code with legitimate codes stored in a memory of said transponder,
creating said operating signal to operate said RFID upon coincidence of said selected electronic code with said legitimate codes.

3. A method according to claim 2 wherein said operating signal controls activating operating power of said transponder.

4. A method according to claim 2 wherein said operating signal controls parameters of said transponder.

5. An apparatus for providing RFID tags with security options, comprising
means for forming a control signal for operating a RFID transponder of said tags,
means for transmitting said control signal to said RFID transponder,
processing means for assessing said control signal received by said RFID transponder,
means for creating an operating signal for operating said RFID transponder upon acceptance of said control signal by said processing means.

6. An apparatus according to claim 5 wherein said means for creating an operating signal includes means carrying a specific code in said control signal.

7. An apparatus according to claim 6 wherein said means carrying a specific code includes shaped features for code reading.

8. An apparatus according to claim 6 wherein said means carrying a specific code is a magnetic carrier.

9. An apparatus according to claim 6 wherein said means for carrying a specific code is an auxiliary RFID transponder.

10. An apparatus according to claim 9 wherein said auxiliary RFID includes means for providing said transponder with operating power.

11. An apparatus according to claim 10 including means for connecting said transponder to power supply of a primary transponder.

12. An apparatus according to claim 10 including means to induce a voltage in coils of said auxiliary transponder to supply said transponder.

13. An apparatus according to claim 12 including magnetic strips embedded into a primary transponder case.

14. An apparatus according to claim 13 including a coil operative to induce a magnetic field in said auxiliary RFID transponder strips embedded into said primary transponder case.

15. An apparatus according to claim 5 wherein said security options are designed features of complete set of RFID system of said apparatus maintained in a storage.
